(19) United States
(12) Patent Application Publication
(10) Pub. No.: US 2024/0253727 A1
(43) Pub. Date: Aug. 1, 2024

(54) MULTI-FUNCTIONAL FOLDABLE CHILDREN'S TRICYCLE AND ITS MODE OF OPERATION

(71) Applicant: Fujian Besrey Technology Co., Ltd., Fujian (CN)

(72) Inventors: Long Zhao, Fujian (CN); Jinwen Chen, Fujian (CN)

(73) Assignee: Fujian Besrey Technology Co., Ltd., Fujian (CN)

(21) Appl. No.: 18/104,381

(22) Filed: Feb. 1, 2023

(51) Int. Cl. B62K 9/02; B62K 15/00; B62K 21/12; B62K 21/24

(52) U.S. Cl. CPC B62K 9/02; B62K 15/006; B62K 21/125; B62K 21/24; B62K 2015/001; B62K 19/10

(57) ABSTRACT

Disclosed is a multifunctional foldable children's tricycle and its operating method, which includes a front frame and a rear frame connected by a main beam. A front directional wheel is provided on the front frame of the tricycle; a steering handle and rear wheels are provided on the rear frame of the vehicle. The steering handle is connected to the front steering wheel by a synchronous wire rope linkage assembly (1). The synchronous wire rope link assembly (1) comprises a guide block and a front guide piece, and guides and limits the wire rope through the guide block and the front guide piece. The multi-functional foldable children's tricycle has a simple structure, more stable steering operation and convenient folding.

### TECHNICAL FIELD

The invention relates to the field of children's tricycles, in particular a multi-functional foldable children's tricycle and its mode of operation.

### BACKGROUND

The state-of-the-art children's tricycle consists of a frame, a front wheel, two rear wheels arranged on either side of the frame respectively, a push handle and a saddle installed on the tricycle frame.

The tricycle frame includes a front fork, a front vertical tube rotatably arranged with the front fork, and a rear wheel support.

Usually the front end of the rear wheel bracket and the front riser are fixedly connected as a whole, so that the children's tricycle cannot be folded, with large volume and high transportation costs. A small number of foldable designs have tedious operating steps that cannot be performed by one person.

The children's tricycle is deeply appreciated as a kind of walking equipment. For the convenience of indoor storage and outdoor transport, some state-of-the-art children's tricycles can be folded. At the same time, some children's tricycles need to adjust the opening and closing angle of the rear wheels to reduce the occupied space or realize the use of multiple angles, but the current angle adjustment method of opening and closing is unreasonable. In addition, the operation is tedious, the adjustments cannot be made alone, and therefore does not make it possible to obtain synchronous rotation.

The connection between the traditional steering push handle and the handlebar is complicated and the cost is high. It is therefore difficult to disassemble and assemble in the event of a breakdown and the maintenance cost is high. There is a connecting structure through a wire rope, but its structural design is unreasonable. Stability is poor and it is easy to rock up and down when cornering, and in severe cases mutual wear or binding occurs.

### SUMMARY

Aiming at the shortcomings of the above problems, the present invention provides a multifunctional foldable children's tricycle and its operating method.

In order to solve the technical problems mentioned above, the present invention provides a multifunctional foldable children's tricycle, comprising a front frame and a rear frame connected by a main beam; the front frame is provided with a steering wheel, and the rear frame is provided with a steering handle and two rear wheels arranged on the steering handle. The steering handle and the steering wheel are connected by a synchronization wire rope link assembly. The timing wire rope link assembly includes a guide block and a front guide piece. The timing wire rope linkage assembly is configured to guide and limit wire rope movement through the guide block and the front guide piece. The rear frame of the tricycle is connected to the rear wheels via an opening and closing angle adjustment assembly. The opening and closing angle adjustment assembly includes a synchronization plate and a synchronization bar. The rear wheels of the tricycle are configured to achieve synchronous rotation through a coordinated action of the synchronization plate and the synchronization bar. The rear end of the tricycle main beam and the rear tricycle frame are hinged and positioned by a collapsible assembly.

As a further particular improvement of the invention, the front frame of the tricycle is vertically penetrated with a handlebar rotatably connected thereto. The lower end of the handlebar is connected with the front wheel, and a seat is installed on the main beam. The timing wire rope linkage assembly includes a rear positioning block fixedly connected to the lower end of the rear steering handle. The rear positioning block is equipped with two positioning grooves for positioning the rear ends of a left wire rope and a right wire rope respectively. The guide block is arranged on the front side of the rear positioning block. The guide block is provided with two through slots through which two metal cables pass. The upper end of the guide block is recessed into the bottom of the rear frame of the tricycle through a block. The front ends of the two wire ropes pass through the main beam of the tricycle and are connected to the front frame of the tricycle. A forward positioning block is sleeved and secured to the handlebar along its outer periphery. The front positioning block is provided with two front positioning grooves for positioning the front ends of the left wire rope and the right wire rope respectively. The rear frame of the tricycle is fixed with a sleeve to insert and rotate the steering handle. The lower end of the steering handle passes through the sleeve and is fixed coaxially to the rear positioning block. The rear positioning block is equipped with a first arcuate groove for two wire ropes to be wound inward along its outer periphery. Both ends of the first upper arc groove are respectively connected to the two rear positioning grooves. The front positioning block is equipped with a second upper arc groove for two wire ropes to be wound inward along its outer periphery, and both ends of the second upper arc groove are respectively connected to the two grooves forward positioning. A convex piece protrudes upward symmetrically from the top of the guide block on the left and right sides of the through slot, and holes (preferably small) are opened on the left and right sides of the convex piece, and are plugged and locked by pin rods.

As a further improvement of the invention, the main beam of the tricycle has the shape of a hollow metal tube, and its lower end is equipped with a circular opening for the passage of the metal cable.

The steel cable is provided with a protective sheath after being inserted into the through groove.

The two ends of the protective sheath are fixed coaxially to a metal block whose outer diameter is greater than that of the protective sheath.

The wire rope passes through the metal block. A protective sheath limiting groove for limiting the protective sheath is opened in the through groove. A metal block installation groove for placing the metal block is coaxially opened in the limiting groove of the protective sheath. The installation groove of the metal block, the limiting groove of the protective sheath and the top of the through groove all pass through the guide block.

As a further improvement of the invention, the front positioning block is connected to the handlebar. The faces of the upper and lower ends of the front positioning block are fixedly connected to the handlebar by several vertical positioning blocks. The front handlebar is arranged behind the front positioning block and passes through a guide groove in the shape of a “figure eight” to facilitate the winding of the two steel cables on the positioning block. The handlebar cover is provided with an outer shell and is fixedly connected to the main beam of the tricycle through the outer shell. The front handlebar is tight and integrated between the outer shell and the main beam of the tricycle. The upper end of the guide groove and the front end of the front positioning groove are both provided with a cover plate to prevent detachment, in addition the outer end of the cover plate is positioned through the top connection of the outer shell. The front guidance system includes a handlebar at the top and a directional lever below that coordinates the direction. The inside of the directional lever is hollow and there is a metal dome near the top end. One end of the metal dome is connected to the inner wall of the directional lever, and the other end is fixed to the elastic button.

The outer end of the elastic button passes through the directional lever. The handle is coaxially inserted and covered on the outside of the directional lever, and the handle is provided with an opening for the elastic button to protrude and connect with the disassembly button. The lower end of the handlebar is covered and fixedly connected to a shell. The disassembly button is arranged horizontally between the handlebar and the shell, the outer end of the disassembly button passes through the inner end of the shell and attaches to the opening.

As a further improvement of the invention, the set of opening-closing angle adjusters comprises a left oscillating element and a right oscillating element which pass through a vertical rotary rod in the rear frame of the tricycle to be connected rotating to each other. There is a relief opening for the installation of the synchronization plate between the left oscillating part and the right oscillating part. The synchronization plate coincides with the center of the left and right swing parts and passes through the rotating rod, and a band-shaped hole is opened on the synchronization plate. A left sync band is hinged to the lower end surface of the left swing member, and a right sync band is hinged to the opposite surface of the right swing member and the lower end surface of the left oscillating element. The side of the left synchronous bar away from the hinge with the left swing part and the side of the right synchronous bar away from the hinge with the right swing part are respectively located on the upper and lower sides of the bar-shaped hole, passing through the articulated joints in turn through a synchronous round rod.

The strip-shaped hole is opened vertically near the rear end of the timing plate, and the strip-shaped hole extends forward and backward.

The left synchronous bar and the right synchronous bar both extend obliquely from the bar-shaped hole.

As a further improvement of the invention, the left rocker has a cylindrical shape and a left leg attached to the left side of the left rocker block. The right swing member includes a cylindrical shape, which is used to clamp the upper right swing block and the lower right swing block arranged on the upper and lower sides of the left swing block. The right side of the upper right swing block and the lower right swing block is fixedly connected with a right leg symmetrical to the left leg, and there is an opening between the right swing block and the left swing block. The upper right oscillating block is pierced vertically with a quasi-elliptical through hole. A boundary block is inserted into the through hole. The inner wall of the through hole is protruded with a convex line to facilitate the synchronous swing of the limit block and the upper right swing block. The upper surface of the left swing block faces downward and is provided with a limit groove for inserting the lower end of the limit block.

The limitation slot extends in an arc of a circle along the circumferential direction of the left rocker block. The upper surface of the boundary block is provided with at least two vertically extending transposition holes. Transposition holes are provided with springs. There is an adjustment knob above the limit block and the two springs cooperate with the upper transposition connection. There are at least two left locating holes penetrating vertically through the left sway block. The upper right swing block is provided with at least two right positioning holes which are pivotally fitted to the left positioning hole. When at least one of the right positioning hole and the left positioning hole is coaxial, the bolt is sequentially inserted into the left positioning hole and the right positioning hole from top to bottom for positioning.

As a further improvement of the invention, the housing obtained after combining the left oscillating block and the right oscillating block is provided with a cover on the outside. The left and right sides of the outer cover have openings for extending the left and right legs. The rotating push handle extends down from the top of the case while passing through the case. A backing plate is placed between the outer cover and the boundary block, and the backing plate is fixedly connected to the outer cover. The outer cover has a round hole for the adjustment knob extension. The side of the round hole close to the bearing plate is coaxial with the round hole and has a non-slip groove with a larger diameter than the round hole. The inner end of the adjusting knob combines with the anti-loosening groove through the protruding rim on the outer periphery to prevent it from falling off. The rear end of the adjuster knob protrudes rearward with a ram block, which passes through the backing plate and combines with the slider attached to the top of the two ram springs. The backing plate has a sliding hole for the top block to pass through and sink in with the slider.

As a further improvement of the invention, the lower end of the left rocker block protrudes downward with a left limit plate of the same thickness as the left synchronous bar, and the left limit plate extends horizontally toward the center while crossing rotary push handle. The upper surface of the right lower rocker block protrudes upward with a right limit plate of the same thickness as the right synchronous bar, and the right limit plate extends horizontally toward the center while crossing the rotary push handle. An arc-shaped skid plate is attached to the butt side of the left swing block and left leg. The upper end of the skid plate extends vertically to the same level as the upper end of the upper right sway block. The lower end of the skid plate extends vertically at the same level as the lower end of the right rocker block. The inner end of the skid plate is fixedly connected to the outer wall of the left rocker block.

As a further improvement of the invention, the collapsible assembly comprises a sheet metal part integral with the rear frame and having a U-shaped cross-section. Both sides of the lower end of the sheet metal project downwards with parts convex and are articulated with the main beam of the vehicle through the convex parts. The sheet metal part is provided with a folding button extending vertically and crossing the sheet metal part from the top. The lower end of the folding knob is connected to the inner bottom of the sheet metal part via a return spring. The sheet metal parts are hooked and positioned with the main beam of the vehicle. The rear end of the vehicle's main beam is fixedly connected to a vertical butt plate. The two ends of the butt plate extend backward with wing plates, the lower ends of the two wing plates correspond to the two convex parts and are hinged through the pin shaft. A hooking notch with the hook is provided on the connecting plate. The sheet metal piece has a matching notch and raised opening for the hook to move up and down. The lower end of the folding button is provided upwards with a circular limiting groove for the stopper of the return spring.

In order to solve the technical problems mentioned above, the present invention simultaneously provides a method of operating a multifunctional foldable children's tricycle, which is carried out according to the following steps:

When the children's tricycle needs to turn right, first turn the steering handle to the right to rotate the rear positioning block. When the right wire rope is stretched during the turning process, the left wire rope is forced to pull forward, which synchronously drives the front positioning block to turn right, and then drives the handlebar to turn right. right, that is, the direction the wheel completes the right turn and completes the right turn of the children's tricycle. Reverse analogy for a left turn.

When it is necessary to adjust the opening and closing angle between the rear wheels of the tricycle, pull the latch first, then press the adjustment button down. Press the sliding hole slider into the transposition hole to compress the spring, then rotate one of the legs inward or outward, that is, the right support leg is tilted inward to cause the right synchronous bar to swing forward into the bar-shaped hole.

Through the connection of the synchronous round rod, the left synchronous bar synchronously swings forward in the bar-shaped hole, that is, the left leg is trained to swing forward. inside synchronously to realize the synchronous swing, and at the same time, the sliding block slides on the sheet metal part through the upper connection of the spring. After the oscillating block is in place, the other transposition holes cooperate with the sliding holes to be pushed through the stretching of the spring, and are connected to the adjustment button again, and the adjustment button is released to complete the rotation.

When the rear frame of the tricycle needs to be folded, by pressing the folding button, the return spring is compressed, the hook descends, and the whole rear frame of the tricycle can be rotated forward around the hinge point at the same time. time, so that the hook comes out of the notch and the folding button can be released. The return spring resets to complete the folding work of the rear frame and the main beam.

The beneficial effects of the present invention over the previous one are:

With the wire rope link design, the link structure is simpler, the disassembly and assembly are more convenient, and the cost is reduced. The wire rope is guided by the rear guide block and the front handlebar to ensure that it does not swing up and down when turning and to make it much more stable.

It is possible with one hand to press the adjustment button down, and the other hand can swing the tricycle leg, and through the coordinated design of the synchronous plate and the synchronous bar, only one leg can be switched to swing the other synchronously, that is, only one person can complete the operation. The operation is simple and convenient, and at the same time, adjusting the opening and closing angle can also reduce the occupied space and facilitate storage.

By pressing the folding button to lower the hook, the whole rear frame can be swung forward around the hinge point at the same time, so that the hook can come out of the notch, and the folding process of the rear frame and the main frame is finished. The operation steps are simple, convenient and easy to fold. Only one person can complete the folding process.

### BRIEF DESCRIPTION OF DRAWINGS

In order to more clearly illustrate the technical details of this application, the attached illustrations which are to be used in the implementation will be briefly presented below. Of course, the illustrations appended in the following description are only a few implementations of the application. As for those who are of this field or have technical skills, other illustrations can also be obtained from these attached illustrations without creative effort.

FIG. 1 is the structural representation of the embodiment of the present invention;

FIG. 2 is the top view of the embodiment of the present invention;

FIG. 3 is the sectional view of G-G of FIG. 2;

FIG. 4 is a structural diagram of the wire rope bonding assembly in the embodiment of the present invention;

FIG. 5 is the connection diagram of a wire rope in the embodiment of the present invention;

FIG. 6 is a schematic structural view of the rear positioning block in one embodiment of the present invention;

FIG. 7 is a schematic structural view of a guide block in one embodiment of the present invention;

FIG. 8 is a block diagram of the connection structure between the front positioning block and the handlebar in the embodiment of the present invention;

FIG. 9 is a structural diagram of a steel wire rope in an embodiment of the present invention;

FIG. 10 is a schematic structural view of the opening and closing angle adjustment assembly in the embodiment of the present invention;

FIG. 11 is a rear view of the opening and closing angle adjustment assembly in the embodiment of the present invention;

FIG. 12 is the sectional view from D-D of FIG. 11;

FIG. 13 is the sectional view of E-E of FIG. 11;

FIG. 14 is a schematic diagram of the overall structure of the rear frame of the tricycle in the embodiment of the present invention;

FIG. 15 is a top view of FIG. 14;

FIG. 16 is a sectional view of F-F of FIG. 15;

FIG. 17 is a schematic diagram of the structure of the right oscillating member in the embodiment of the present invention;

FIG. 18 is a schematic diagram of the structure of the left swinging member in the embodiment of the present invention;

FIG. 19 is a bottom view of the left swinging member in the embodiment of the present invention;

FIG. 20 is a schematic diagram of the structure of the folding assembly in the embodiment of the present invention;

FIG. 21 is a block diagram of the internal structure of the folding assembly in the embodiment of the present invention;

FIG. 22 is a schematic structural view of the rear frame of the tricycle in the embodiment of the present invention;

FIG. 23 is a schematic structural view of the main beam of the vehicle in the embodiment of the present invention;

FIG. 24 is a schematic diagram of the structure of the folding button in the embodiment of the present invention;

FIG. 25 is a schematic structural view of the handlebar in one embodiment of the present invention;

FIG. 26 is a schematic diagram of the internal structure of the handlebar in the embodiment of the present invention.

In the illustrations: 1. Synchronous Wire Rope Link Assembly; 2. Opening and closing angle adjustment assembly; 3. Folding assembly; A1, steering wheel; A2, directional push handle; A3, left oscillating part; A4, right oscillating part; A6, Opening; A7, strip-shaped hole; A8, left synchronous bar; A9, right synchronous bar; A10, synchronous round rod; A11, left rocker block; A12, left leg; Right sway block; A15, right leg; A16, hole; A17, boundary block; A18, convex line; A19, boundary groove; A20, transposition hole; A21, spring; Positioning hole; A24, right positioning hole; A25, latch; A26, outer cover; A27, harbor; A28, bearing plate; A29, round hole; sliding hole; A34, left limit plate; A35, right limit plate; A36, skid plate; B1, main beam; B2, front frame; B3, rear frame; B4, steering handle; B5, rear positioning block; B6, left wire rope; B7, straight wire rope; B8, rear positioning slot; B9, guide block; B10, through slot; B11, block; B12, handlebar; B13, front positioning block; B14, front positioning slot; B15, clamp piece; B16, housing; B17, first upper arc groove; B18, second upper arc groove; B19, bump; B20, round hole; B21, protective cover; B22, metal block; B23, protective sleeve limit groove; B24, metal block installation groove; B25, circular aperture; B26, vertical boundary block; B27, front guide piece; B28, guide groove; B29, outer shell; B30, cover plate; B31, handlebar; B32, drive shaft; B33, Metal Dome; B34, elastic button; B35, disassembly button; B36, aperture; B37, shell; C3, sheet metal part; C4, convex part; C5, flip button; C6, return spring; C7, hook; C8, notch; C9, main beam; C10, connecting plate;
C11, wing-shaped plate; C12, axial rod; C13, relief opening; C14, boundary circular groove; C15, fixed plate; C16, connection plate; C17, seat; C18, rear wheel.

### DESCRIPTION OF EMBODIMENTS

The following will clearly and completely describe the technical solutions in the embodiments of the application with reference to the illustrations in the embodiments of the application. The described embodiments are only some of the embodiments of this application, not all. Based on the embodiments of this application, any other embodiment obtained by those who are in the art or have technical skill without special creative effort is within the scope of the present invention.

Reference herein to “an embodiment” or “implementation” means that a particular feature, structure, or feature described in connection with an embodiment or implementation may be included in at least one embodiment of this application. Occurrences of this phrase at various places in the description do not necessarily all refer to the same embodiment, and separate or alternate embodiments are not mutually exclusive of other embodiments. It is explicitly and implicitly understood by those who are in this field or who have technical skills that the embodiments described here can be combined with other embodiments.

In this specification, for convenience, “middle”, “upper”, “lower”, “front”, “rear”, “vertical”, “horizontal”, “top”, “bottom”, “inner”, “external” and other words indicating orientation or positional relationship are used to illustrate the positional relationship of the constituent parts by reference to the illustrations, which are there only for the convenience of describing this specification and simplifying the description, rather than stating or implying that the device or should have a specific orientation, are constructed and operate in a particular orientation and are therefore not to be construed as limiting the present invention. The positional relationship of the constituent elements is suitably changed according to the direction of the constituent elements described. Therefore, it is not limited to the words and phrases described in the specification and may be appropriately replaced depending on the circumstances.

In this specification, unless otherwise specified and limited, the terms “installation”, “connection” and “connection” are to be interpreted broadly. For example, it can be a fixed connection, or a removable connection, or an integral connection; it may be a mechanical connection, or an electrical connection; it can be a direct connection, or an indirect connection via an intermediate part, or an internal communication between two components. Those in the art or with technical skills can understand the meanings of the above terms in this disclosure depending on the situation.

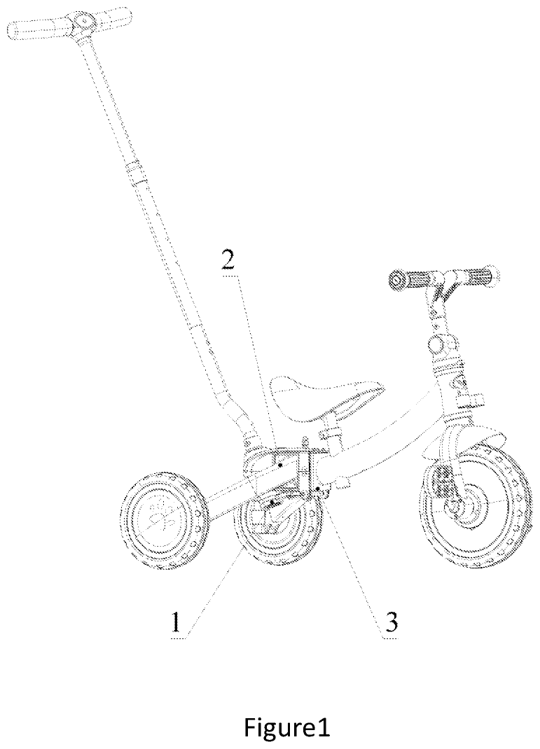

Please refer to FIGS. 1˜26, a multifunctional foldable children's tricycle and its working method provided by the present invention solve the problems of the existing children's tricycle such as the inconvenience of single person folding and storage, technical problems of asynchronous rotation of both legs and instability of the handlebar controlled by the steering handle.

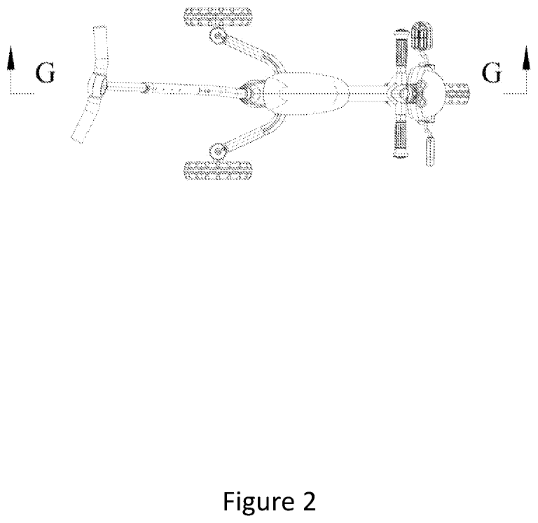

Embodiment 1, as shown in FIGS. 1 to 3, a kind of multifunctional foldable children's tricycle provided by the present invention comprises the front frame B2 and the rear frame B3 connected by the main beam of the tricycle B1, and the frame before B2 vertical. There is a B12 handlebar connected to it in rotation; the lower end of the handlebar B12 is connected to the directional wheel A; the rear frame B3 is traversed by a steering handle B4 which is connected to it in rotation; the steering handle B4 and the handlebar B12 are connected by the synchronous wire rope connection assembly 1; both sides of the B3 rear frame are equipped with C18 rear wheels, and the C18 rear wheels and the B3 rear frame are connected through the opening and closing angle adjustment assembly 2; The rear end of the main beam of the vehicle B1 and the rear frame B3 are positioned through the folding assembly 3; the C17 seat is installed on the main beam of the B1 tricycle.

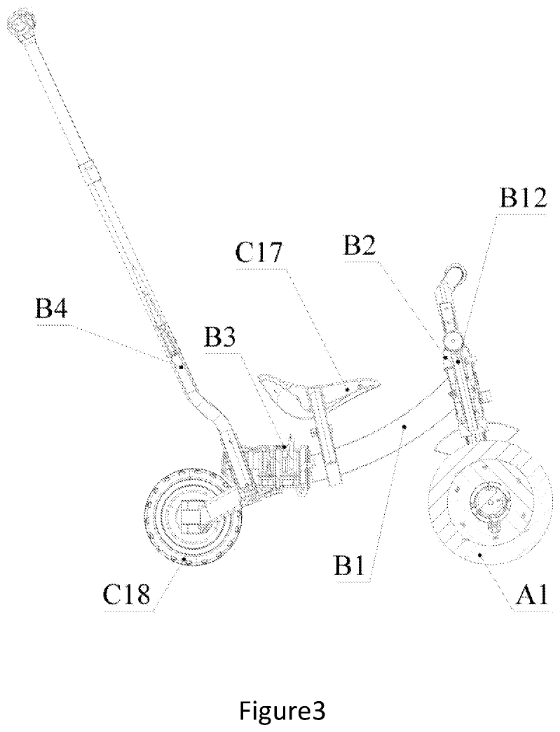

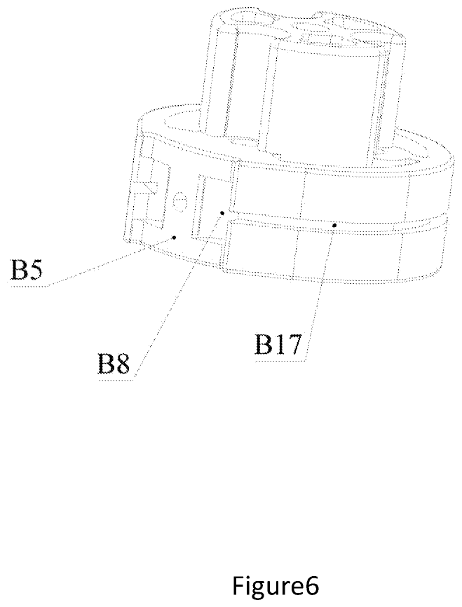

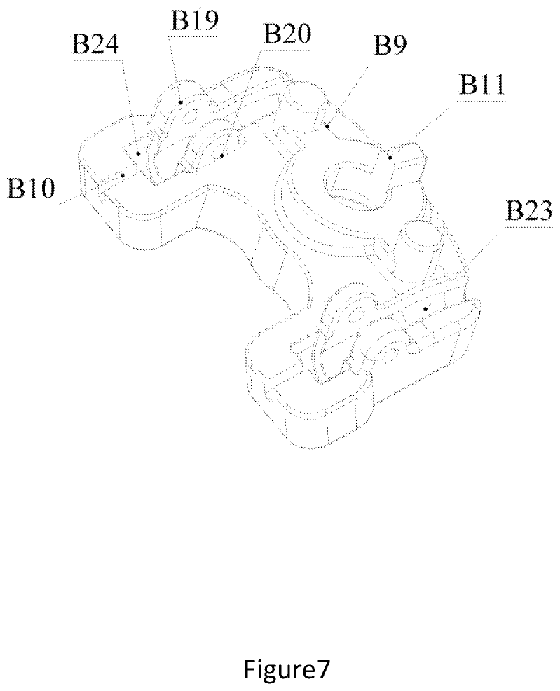

As a preferred embodiment of the present invention, as shown in FIGS. 3 to 5, the rear frame B3 is rotatably connected to a steering handle B4 and the lower end of the steering handle B4 passes through the frame. rear B3 and is fixedly connected to a rear positioning block B5 (See FIG. 6); There are two rear positioning grooves B8 on the rear positioning block B5 for positioning the rear ends of the left steel cable B6 and the right steel cable B7 respectively, and a guide block B9 is provided on the front side of the block rear positioning B5 (see FIG. 7); There are two through grooves B10 through the front and back of the B9 guide block for the passage of the two steel cables. The upper end of the guide block B9 is recessed into the bottom of the rear frame B3 through the clamp block B11. The front ends of the two wire ropes pass through the main beam B1 and are connected to the front frame B2.

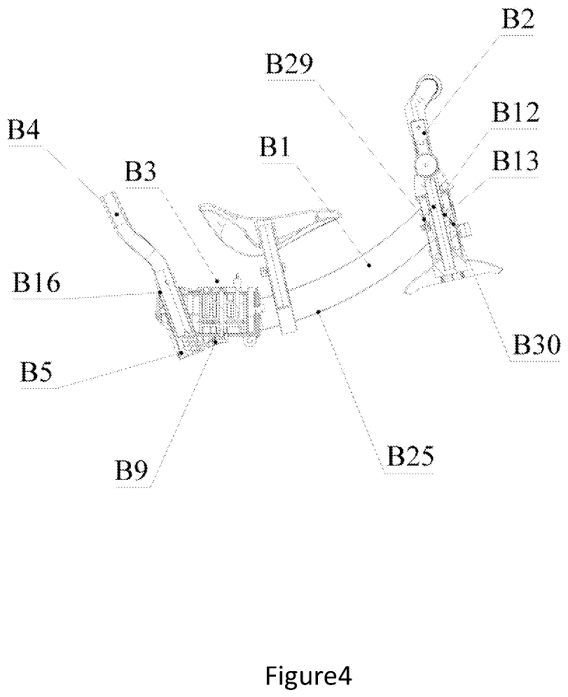

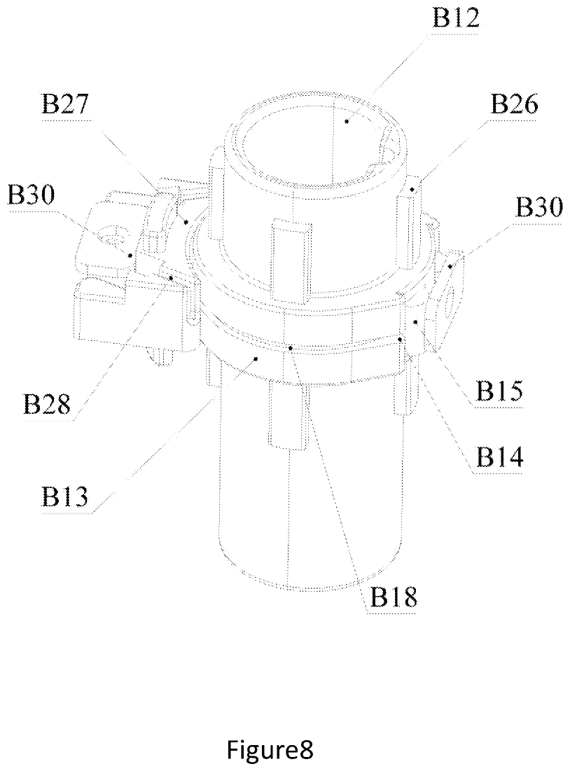

As shown in FIG. 4, the rear frame B3 is fixed with a sleeve B16 to insert and rotate the steering handle B4, and the steering handle B4 can be flanged in the sleeve B16 or the upper end can be bent through the sleeve B16 its vertical limit. The lower end of the steering handle B4 passes through the housing B16 and is coaxially connected to the rear positioning block B5. As shown in FIG. 6, the rear positioning block B5 is provided with a first arcuate groove B17 for two wire ropes to be wound inward along its outer circumference. The two ends of the first upper arc groove B17 are respectively connected to the two rear positioning grooves B8; As shown in FIG. 8, the front positioning block B13 is provided with a second upper arc groove B18 along its inward outer circumference for the two steel wire ropes to wrap around.

As shown in FIG. 7, the convex block B19 projects upward symmetrically from the left and right sides of the through groove B10 at the top of the guide block B9. The B20 small holes are open on the left and right sides of the convex groove. The convex block B19 and is inserted and locked by pin pins. The lock can limit the sliding of the wire rope back and forth only in the B10 channel, effectively avoiding the phenomenon of shaking the wire rope up and down and ensuring its stability when in use.

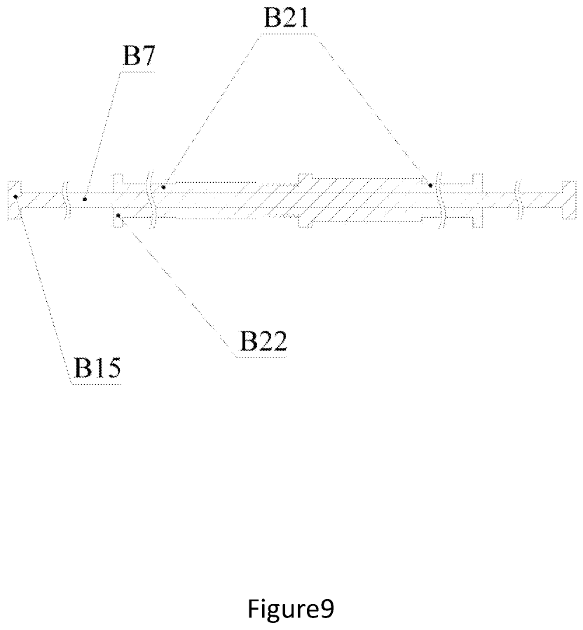

As shown in FIG. 7 and FIG. 9, the steel cable is provided with a protective cover B21 after being inserted into the through groove B10. Both ends of the protective sheath B21 are fixed coaxially to a metal block B22 whose outer diameter is larger than that of the protective sheath B21, and the steel cable passes through the metal block B22.

The through groove B10 is provided with a protective cover limit groove B23 for the protective cover limit B21. A metal block installation groove B24 for placing the metal block B22 is coaxially provided in the protective sheath limit groove B23 and the metal block installation groove B24. The limit slot B23 of the protective sheath and the top of the through slot B10 pass through the guide block, so as to facilitate the installation of the wire rope and make the disassembly and assembly more efficient and convenient.

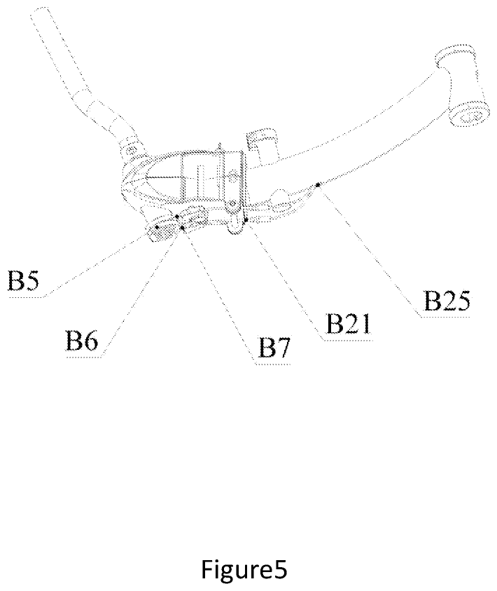

As shown in FIG. 5, the main beam B1 of the tricycle has the shape of a hollow metal tube, and its lower end is provided with a circular opening B25 for the passage of the metal cable.

As shown in FIGS. 1 to 9, the front positioning block B13 is secured to the handlebar B12; The upper and lower end surfaces of the front positioning block B13 are fixedly connected to the handlebar B12 by several vertical positioning blocks B26; The front B13 rear positioning block is fitted with the front B27 guide piece; The front guide piece B27 is drilled with a guide groove B28 in the shape of a “figure eight” to facilitate the winding of the two wire ropes on the positioning block. The shell of the handlebar B12 is provided with an outer shell B29 and is fixedly connected to the main beam of the tricycle B1 via the outer shell B29.

The front guide piece B27 is clamped between the outer shell B29 and the main beam of the vehicle B1.

As shown in FIG. 8, the upper end of the guide groove and the front end of the front positioning groove are covered by the cover plate B30 to prevent falling, and the outer ends of the cover plate are all positioned by the top connection of the outer casing.

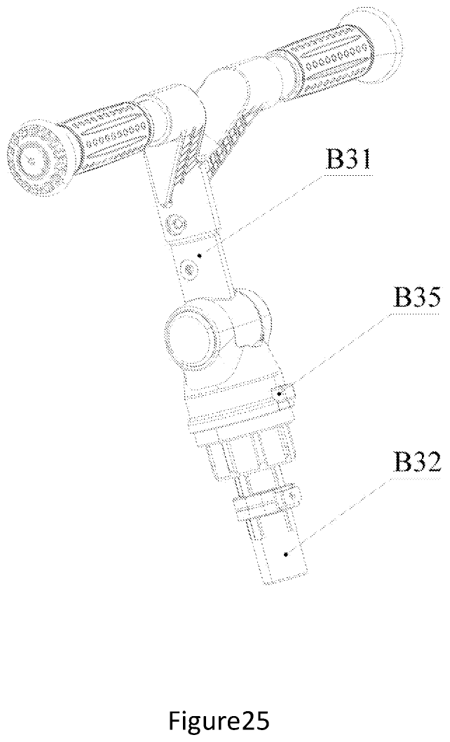

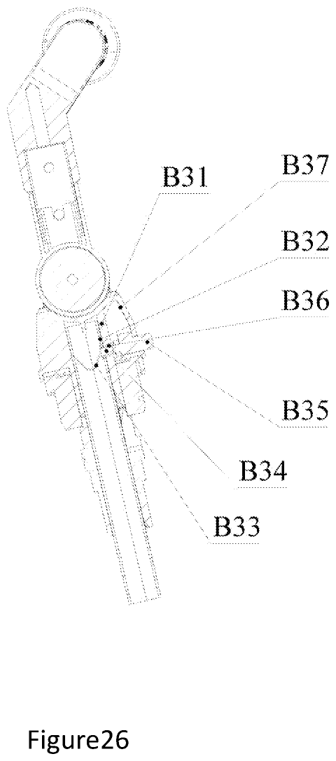

As shown in FIG. 25 and FIG. 26, the handlebar B12 includes an upper handle B31 and a transmission shaft B32 below to drive the steering. The B32 driveshaft is hollow inside and has a B33 chip near the top. One end of the splinter B33 is connected to the inner wall of the driving rod B32, The other end is fixed on the elastic button B34; the outer end of the elastic button B34 passes through the transmission shaft B32; The handle B31 is coaxially inserted and wrapped around the transmission shaft B32, and the handle B31 is provided with an opening B36 for the elastic button B34 to protrude and abut against the disassembly button B35. The lower end of the handle B31 is covered with a shell B37 and secured thereto. The disassembly button B35 is arranged horizontally between the handle B31 and the shell B37, and the outer end of the disassembly button B35 passes through the shell B37, and the inner end is connected with the opening. The handle B31 and the transmission shaft B32 can be provided with a synchronous groove to facilitate synchronous rotation. When disassembling, press the disassembly button B35 inward, and the disassembly button B35 pushes the elastic button B34 inward to come out of the opening. The B33 metal dome is compressed and the B31 handle can be removed at this time to complete the disassembly. When installing, insert the handle B31 outside the driveshaft B32, then push the elastic button B34 into the opening under the metal dome reset B33 to complete the installation. The disassembly process is simple and convenient.

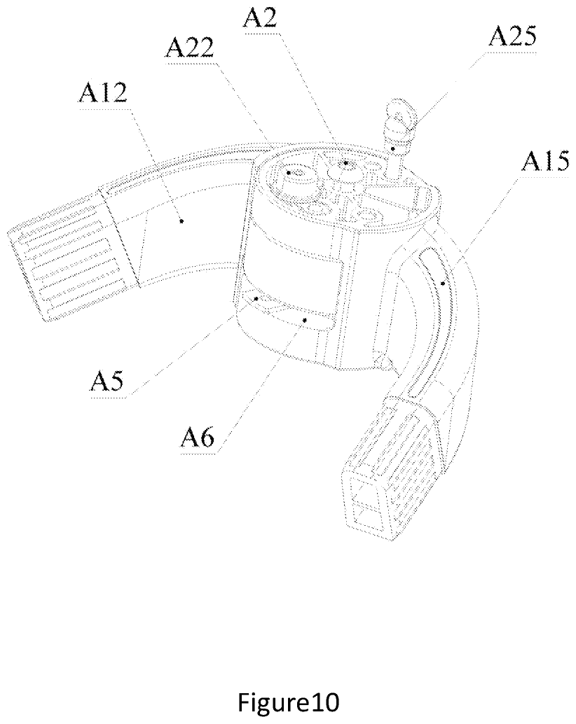

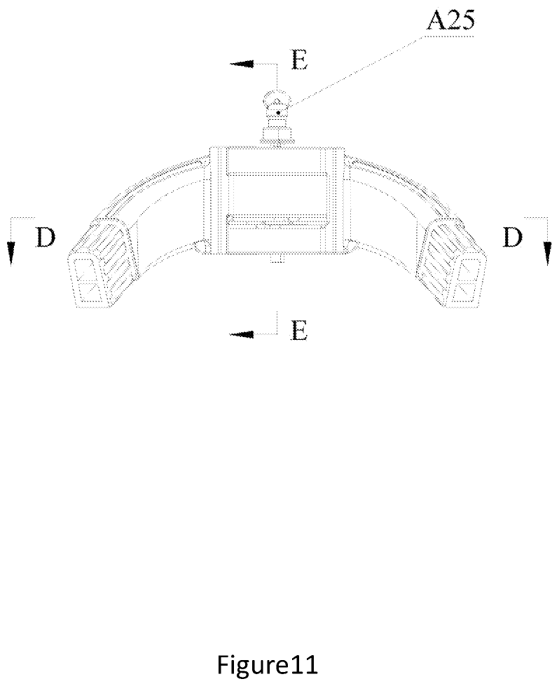

As shown in FIGS. 10 to 12, the rear frame B3 comprises a left swinging part A3 and a right swinging part A4 which pass through a vertical rotary rod A2 to rotate and connect with each other. There is a relief port A6 for installing the synchronous plate A5 which overlaps the center of the left and right swing parts and passes through the rotary rod A2; the A5 synchronous plate extends forward and backward in a band shape, and the A5 synchronous plate is provided with an A7 band hole. The lower end surface of the left swing part A3 is hinged with a left synchronization bar A8, and the opposite surface of the right swing part A4 and the lower end surface of the left swing part A3 is hinged with a bar right synchronization bar A9, and the left synchronization bar A8 is remote from the articulated side and from the right side of the left oscillating part A3. The sides of the synchronous bar A9 away from the hinge with the right swinging member A4 are respectively located on the upper and lower sides of the bar-shaped hole A7, and are hinged sequentially by a synchronous round rod A10.

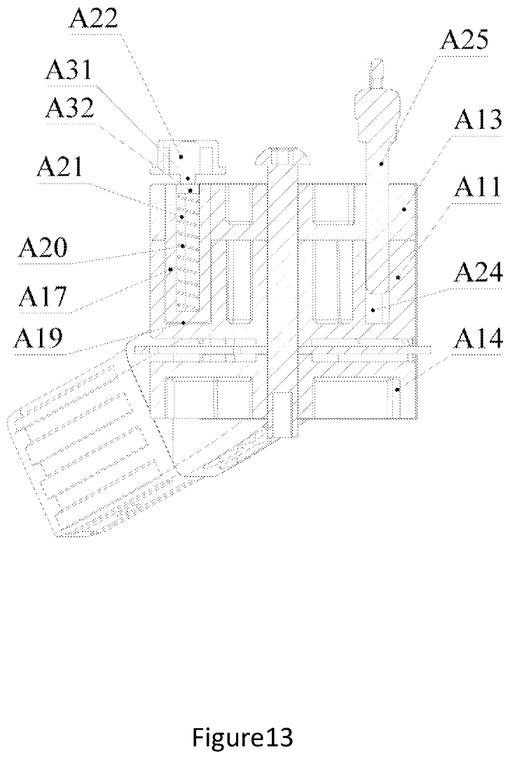

As shown in FIGS. 10 to 13, the left swing part A3 comprises a cylindrical left swing block A11 and a left leg A12 fixedly connected to the left side of the left swing block A11, and the right swing part A4 comprises a left swing block cylindrical A11 for tightening on the left oscillating block. The upper right swing block A13 and the lower right swing block A14 on the upper and lower sides of the block A11, the upper right swing block A13 and the lower right swing block A14 are fixedly connected with the right leg A15 symmetrical to the leg left side A12 on the right side, and the relief opening is open at the lower right rocker block A14. Between the left swing block A11, the rear wheels C18 are respectively installed on the rear ends of the two. As for the angle of the rear wheels after adjusting the opening and closing angle, it is a general technique to adjust the angle of the rear wheels to be parallel to the left and right, this which will not be done here. We won't go into too much detail here.

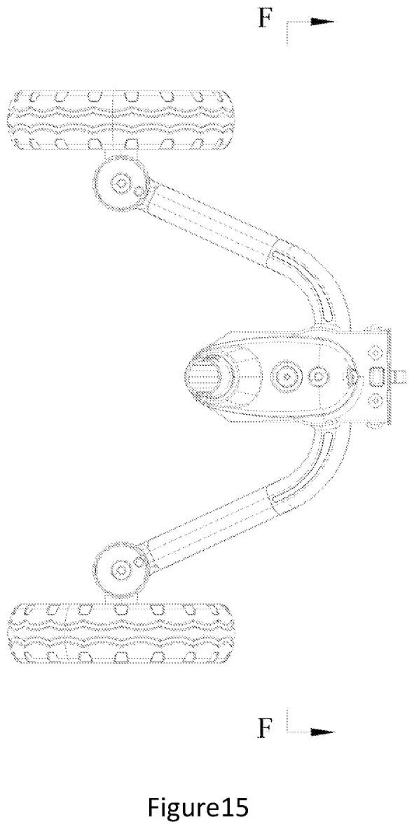

As shown in FIGS. 10 to 19, the upper right oscillating block A13 enters vertically through a quasi-elliptical through-hole A16, and a boundary block A17 is inserted into the through-hole A16. The inner wall of the through hole A16 protrudes with a convex line A18 to facilitate the synchronous swing of the limit block A17 and the upper right swing block A13. The upper surface of the left swing block A11 is concavely provided with a limit groove A19 for inserting the lower end of the limit block A17, and the limit groove A19 extends along the arc direction of the pendulum block left A11. The upper surface of the boundary block A17 is provided with two transposition holes A20 extending vertically, and springs A21 are arranged in the transposition holes A20. There is an A22 adjustment knob on top of the A17 limit block, and the two springs cooperate with the top transposition connection.

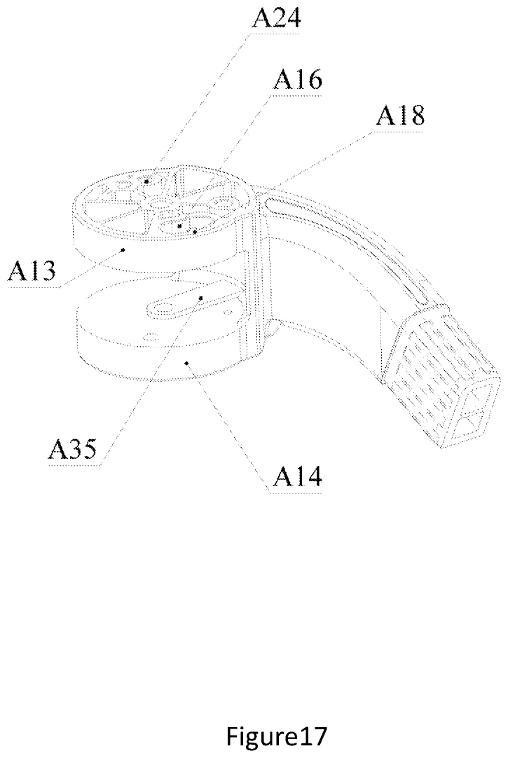

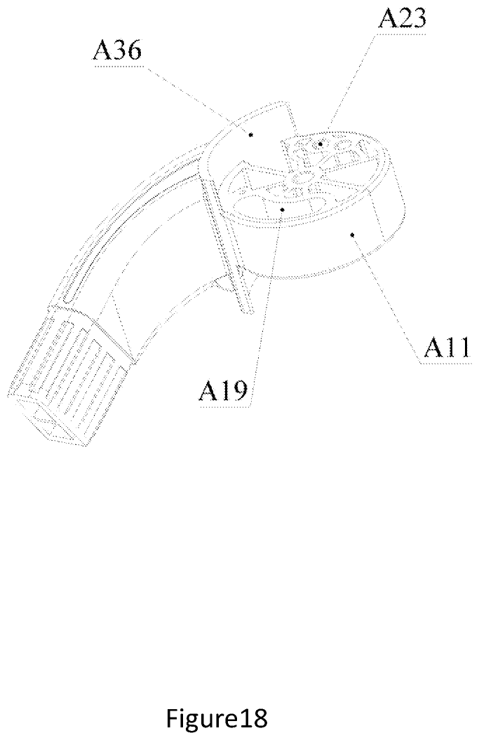

As shown in FIG. 18, there are at least two left locating holes A23 penetrating vertically through the left rocker block A11. As shown in FIG. 17, there are at least two right positioning holes A24 which are pivotally fitted to the left positioning hole A23 on the upper right swing block A13. When at least one of the right positioning hole A24 and the left positioning hole A23 is coaxial, the bolt A25 is sequentially inserted into the left positioning hole A23 and the right positioning hole A24 from top to bottom for the positioning.

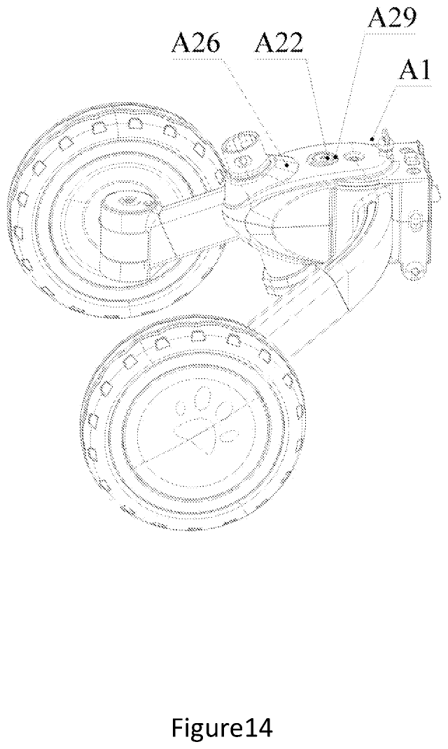

As shown in FIG. 14, the left swing block A11 is combined with the upper right swing part A13 and the lower right swing part A14 to be provided with an outer cover A26. The left and right sides of the outer cover are provided with openings A27 for the left and right legs to stretch, and the rotary rod extends downward from the top of the outer cover A26 to pass the outer cover A26, for that the bottom can be fitted with a nut to prevent it from coming off.

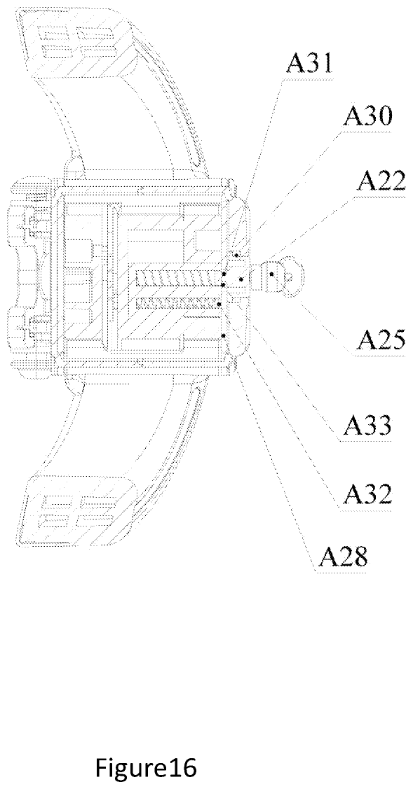

As shown in FIG. 16, a backing plate A28 is placed between the outer cover A26 and the boundary block A17, and the backing plate A28 is fixedly connected to the outer cover A26. The outer cover A26 is provided with a round hole A29 to protrude the adjustment knob A22. The side of the A29 round hole close to the A28 support plate is coaxial with the A29 round hole and has an A30 anti-loosening groove with a larger diameter than the A29 round hole. The inner end of the adjustment knob A22 cooperates with the anti-slip groove A30 through the protruding rim on its outer periphery to prevent it from falling, and the rear end of the adjustment knob A22 protrudes with an upper gasket block A31. The lifting block A31 passes through the bearing plate A28 and cooperates with the slider A32 fixedly connected to the top of the two springs, and the bearing plate A28 is provided with a sliding hole A33 so that the lifting block A31 passes through and pushes into the A32 slider.

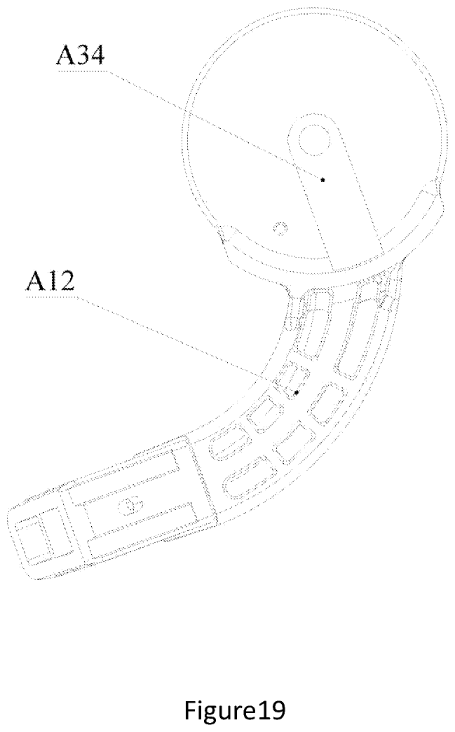

As shown in FIG. 19, the lower end of the left rocker block A11 protrudes downward with the left limit plate A34 having the same thickness as the left synchronous bar A8, and the left limit plate A34 extends horizontally towards the center and passes through the rotating rod A2. As shown in FIG. 17, the upper surface of the right lower rocker block A14 projects upward with a right limit plate A35 of equal thickness to the right synchronous bar A9. The right limit plate A35 extends horizontally towards the center and crosses the rotary rod A2. The left limiting plate A34 is arranged in parallel with the left synchronous bar A8, and the right limiting plate A35 is arranged in parallel with the right synchronous bar A9, which can avoid the reverse tilt of the two synchronous bars when the spin.

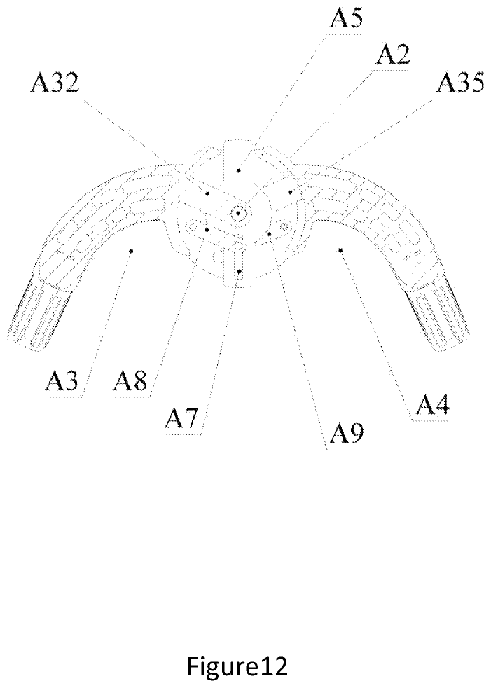

As shown in FIG. 12, the strip-shaped hole A7 is vertically open near the rear end of the timing plate. The bar-shaped hole A7 extends forward and backward, and the left synchronous bar A8 and the right synchronous bar A9 both extend obliquely backward to the bar-shaped hole A7.

As shown in FIG. 18, an arc-shaped shield plate A36 is attached along the stopper side of the left swing block A11 and the left leg A12, and the upper end of the shield plate A36 extends vertically at the same level as the upper end of the upper right rocker block A13.

The lower end of the A36 guard plate extends vertically to the same level as the lower end of the A14 lower right rocker block, and the inner end of the A36 guard plate is fixedly connected to the wall exterior of the left oscillating block A11.

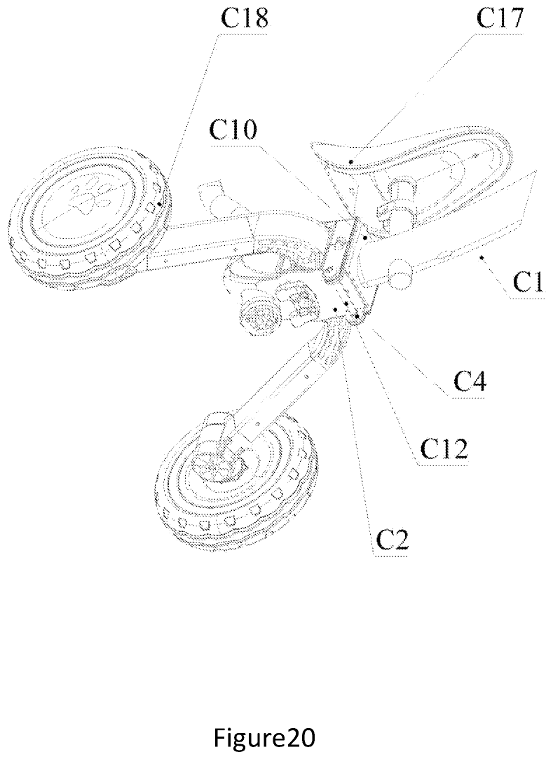

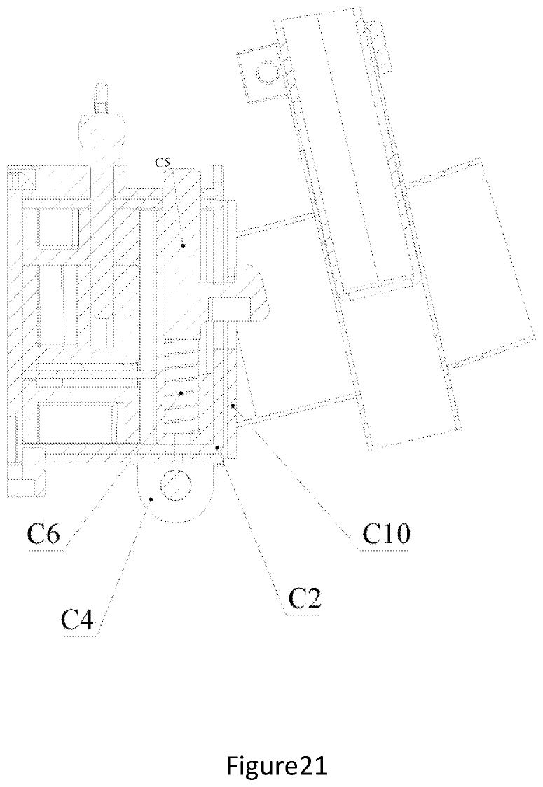

As shown in FIGS. 20 to 24, the rear frame B3 includes a sheet metal part C3 with a U-shaped cross section, and both sides of the lower end of the sheet metal part C3 protrude downward with a convex part C4 and are articulated to the main frame by the convex part C4. The sheet metal part C3 is provided with a folding button C5 which extends vertically and crosses the sheet metal part C3 from above. A hook C7 protrudes horizontally from the front end of the folding button C5 and passes through the sheet metal part C3 to be hinged with the main positioning frame. The rear end of the main frame has a C8 notch hinged with the C7 hook.

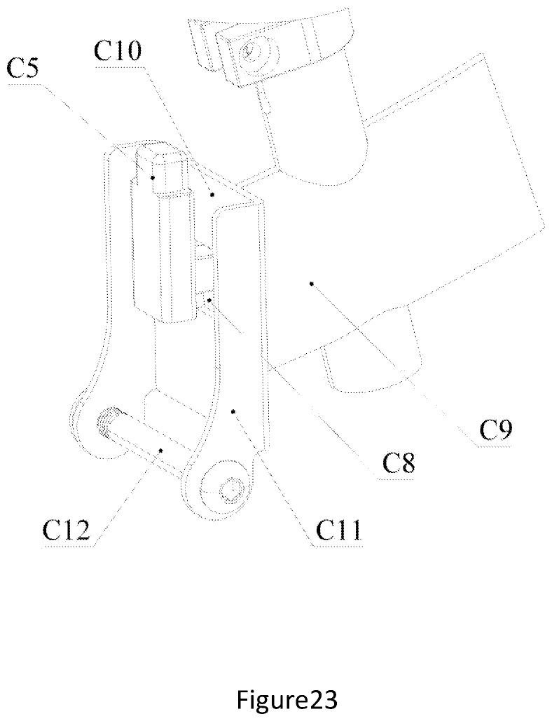

As shown in FIG. 23, the vehicle main frame includes a tricycle main beam C9, and the rear end of the tricycle main beam C9 is fixedly connected to a vertical connecting plate C10. The left and right ends of the C10 link plate extend rearward with a C11 wing-shaped plate. The lower ends of the two wing-shaped plates correspond to the two convex parts and are hinged through the pin axis C12. The wing-shaped plate C11 and the convex part C4 are provided with through holes for the passage of the spindle axis C12.

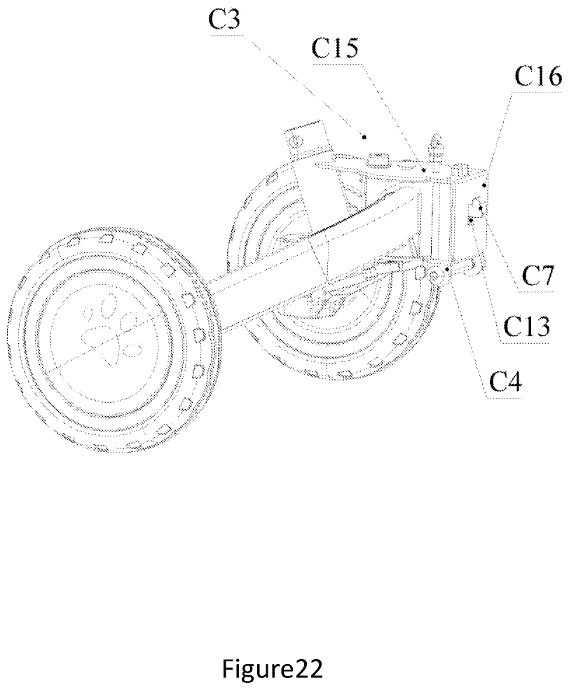

As shown in FIG. 22, the main beam C9 of the tricycle is formed by a hollow tube made of a hard metallic material. The notch C8 is open on the connecting plate C10 and communicates with the interior cavity of the main beam of the tricycle C9. The sheet metal part C3 is provided with a complementary notch C8 and with a clearance opening C13 for moving the hook C7 upwards and downwards. The hook end C7 protrudes obliquely upward to connect with the inner wall of the connecting plate C10 after being inserted into the notch C8 to prevent it from falling off.

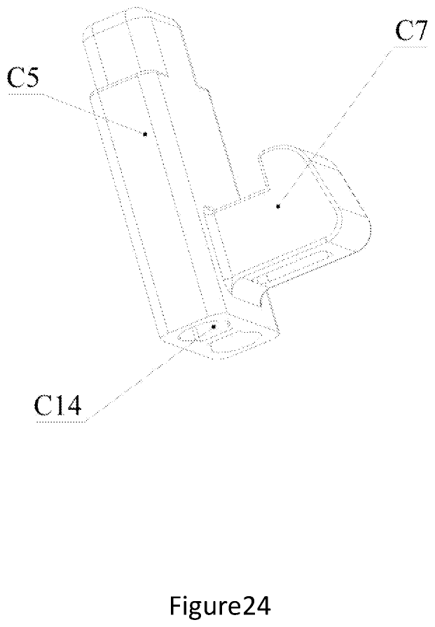

As shown in FIG. 24, the lower end of the folding button C5 is provided upwards with a limiting groove C14 bearing against the spring, which serves to limit the vertical position of the spring and to prevent tilting of the spring. spring to affect the folding button reset.

As shown in FIG. 22, the U-shaped opening of sheet metal part C3 faces rearward and includes a connecting plate C1 which is parallel up and down.

The convex part C4 is integral with the left and right ends of the fixing plate on the lower side. The fixing plate C15, the connection plate C16 and the convex part C4 are formed in one piece.

Embodiment 2; The present invention simultaneously provides a kind of working method of a multi-functional foldable children's tricycle, made by the following steps:

When the children's tricycle needs to turn right, first turn the steering handle B4 to the right to rotate the rear positioning block B5, and then pull the right wire rope B7 to tighten it during the turning process. The left wire rope B6 is forced to stretch forward, and synchronously drive the front positioning block B13 to turn right, then drive the handlebar B12 to turn right, that is, that the front wheel A1 completes the right turn of the children's tricycle.

When it is necessary to adjust the opening and closing angle between the rear wheels of the tricycle, it is necessary to pull the latch A25 first, and then press the adjustment button A22 down, so that the lifting block A31 presses the slider A32 of the sliding hole A33 into the transposition hole A20, and the spring A21 is compressed, then one of the legs can be swung inward and outward, that is, that the right leg A15 is swung inward, and the right synchronous bar A9 is driven to swing forward in the bar-shaped hole A7, and the left is swung through the connection of the synchronous round rod A10; the bar A8 swings forward in the bar hole A7 synchronously, that is, it drives the left leg A12 to swing inward synchronously to realize the synchronous swing. After being put in place, the other transposition holes cooperate with the sliding hole A33 to be stretched and pushed by the spring A21, and are again connected to the adjustment button A22, and the adjustment button A22 is released to complete the spin.

When the rear frame B3 needs to be folded, the folding button C5 should be pressed to compress the return spring C6, and the hook C7 goes down, and the whole rear frame B3 can be rotated forward around the hinge point at the same time, so that the hook C7 can be disengaged from the notch. The C5 folding knob can be loosened, and the C6 recoil spring resets, then the folding process of the B3 rear frame and the C9 tricycle main beam is completed.

In specific use, in order to facilitate the understanding of the present invention, it is described as follows in conjunction with the accompanying drawings:

The working principle of the synchronous wire rope link assembly: When the children's tricycle needs to turn right, first of all, the rear positioning block is driven to turn by turning the steering handle to the right. During rotation, the right wire rope is stretched and then pulled, and the left wire rope is forced to stretch forward, that is, it synchronously drives the front positioning block to turn right, then drive the handlebar to turn right to complete the process of turning the tricycle to the right. When it is necessary to turn left, the process remains the same but in the opposite direction. With the wire rope link design, the link structure is simpler, and the disassembly and assembly are more convenient. The cost is reduced, and the wire rope is guided and limited by the guide block and the front wheel to ensure that it will not shake up and down, left and right when turning, which makes its work more stable. In addition, the steel cable is flexible and adjustable, and the tension can be adjusted using the cable tensioner.

The working principle of the opening and closing angle adjustment component: When it is necessary to adjust the opening and closing angle between the rear wheels of the tricycle, the latch should be pulled first, then press the setting button down, so that the top connection is fast. Press the sliding hole slider into the transposition hole; the spring is compressed, then it can be turned inwards. Swing one of the legs outwards, for example swinging the right leg inwards and causing the right synchro bar to swing forward in the bar-like hole, and the left synchro bar is swung synchronously forward into the bar-shaped hole through the synchronous round rod connection; therefore lead the left leg to swing inward synchronously to achieve synchronous swing. When the right leg swings, the convex block drives the limit block to limit swing in the lower limit groove, which limits the movement of both legs and prevents excessive swinging. At the same time, At the same time, the slider slides over the sheet metal part through the spring-loaded top connection. After the swinging part is in place, the other transposition holes cooperate with the sliding holes to be pushed through the stretching of the spring, and are again connected with the adjustment button, and the adjustment button is released to complete the rotation. At this time, at least one of the right positioning hole and the left positioning hole is coaxial, so that the latch is reinserted for positioning.

Operation of foldable components: When the rear frame of the tricycle needs to be folded, by pressing the folding button, the spring is compressed and the hook descends, and the whole rear frame of the tricycle can be rotated forward around the point of hinge at the same time, so that the hook comes out of the notch, the folding button can be released, and the spring resets to complete the folding process of the rear frame and the main frame. The process steps are simple, and the tricycle is convenient and easy to fold.

The technical means described in the solution contributions of this present invention are not limited to the technical means described in the above embodiments, but also include technical solutions composed of any combination of the above technical characteristics. It should be emphasized that those who are in this field or who have technical skills can make certain improvements or modifications without departing from the principle of the present invention, and these improvements or modifications are also considered to violate the protection of this application.

What is claimed is:

1. Multi-functional folding tricycle for children, comprising a front frame (B2) and a rear frame (B3) connected by a main beam (B1), the front frame (B2) being provided with a steering wheel (A1), the rear frame (B3) being provided with a steering handle (B4) and two rear wheels (C18), characterized in that: the steering handle (B4) and the steering wheel (A1) are connected by a set synchronizing wire rope link assembly, the synchronizing wire rope link assembly comprises a guide block (B9) and a front guide piece (B27), the synchronizing wire rope link assembly synchronizer is configured to guide and limit the movements of the wire rope through the guide block (B9) and the front guide piece (B27), the rear frame (B3) and the rear wheels (C18) are connected by an opening and closing angle adjustment assembly and the opening and closing angle adjustment assembly closure comprises a synchronization plate (A5) and a synchronization bar (A8, A9), the rear wheels (C18) of the tricycle are configured to achieve synchronous rotation through coordinated action of the synchronization plate (A5) and the synchronization bar (A8, A9), the rear end of the main beam of the tricycle (B1) and the rear frame (B2) are articulated and positioned by a folding element.

2. Multifunctional foldable children's tricycle according to claim 1, characterized in that: the front frame (B2) is penetrated vertically with a handlebar (B12) rotatably connected thereto, the lower end of the handlebar (B12) is connected to the front wheel (A1), and a seat (C17) is installed on the tricycle main beam (B1), the synchronization wire rope link assembly includes a rear positioning block (B5) fixedly connected to the lower end of the steering handle (B4), the rear positioning block is equipped with two rear positioning grooves (B8) for positioning the rear ends of a left wire rope (B6) and 'a straight wire rope (B7) respectively, the guide block (B9) is arranged on the front side of the rear positioning block (B5), and the guide block (B9) is provided with two through slots (B10) at through which pass two metal cables, the end s upper part of the guide block (B9) is embedded in the bottom of the rear frame (B3) through a block (B11), the front ends of the two wire ropes pass through the main beam of the tricycle (B1) and are connected to the front frame (B2), a front positioning block (B13) is sheathed and attached to the handlebar (B12) along its outer periphery, the front positioning block (B13) is provided with two front positioning grooves (B14) for positioning the front ends of the left wire rope (B6) and the right wire rope (B7) respectively, the rear frame is fixed with a sleeve (B16) to insert and rotate the steering handle (B4), and the lower end of the steering handle (B4) passes through the sleeve (B16) and is fixed coaxially to the rear positioning block (B5), the rear positioning block (B5) has a first arc groove (B17) for two wire ropes to be wound towards inside along its outer periphery, the two ends of the first upper arc groove (B17) are respectively connected to the two rear positioning grooves (B8), the front positioning block (B13) has a second upper arc groove (B18) for two wire ropes to be wound inward along its outer periphery, both ends of the second upper arc groove (B18) are respectively connected to the two front positioning grooves (B14), a convex part (B19) protrudes upward symmetrically from the top of the guide block (B9) on the left and right sides of the through slot (B10), holes are opened on the left and right sides of the convex part (B19) and are plugged and locked by pin rods.

3. Multifunctional foldable children's tricycle according to claim 2, characterized in that: the tricycle main beam (B1) which is shaped like a hollow metal tube, and its lower end is provided with a round opening (B25) for the passage of the wire rope, the steel wire rope is provided with a protective sheath (B21) after being inserted into the through groove (B10), the two ends of the protective sheath (B21) are fixed coaxially with a metal block (B22) whose outer diameter is larger than the protective sheath (B21), and the steel cable passes through the metal block (B22), a limiting groove (B23) to limit the sleeve protective sleeve (B21) is opened in the through slot (B10), an installation groove (B24) for placing the metal block (B22) is coaxially opened in the limiting groove (B23) of the protective sleeve, the groove d installation (B24) of the metal block e, the limiting groove (B23) of the protective sleeve and the top of the through groove (B10) all pass through the guide block (B9).

4. Multifunctional foldable children's tricycle according to claim 2, characterized in that: the front positioning block (B13) which is fixedly connected to the handlebar (B12), and the upper and lower end surfaces of the block front positioning block (B13) are fixedly connected to the handlebar (B12) via several vertical positioning blocks (B26), the front guide piece (B27) is placed behind the front positioning block (B13) and passes through a guide groove (B28) in the shape of a “figure eight” to facilitate the winding of the two steel cables on the positioning block, the outer surface of the handlebar (B12) is provided with a shell (B29) and is connected fixedly to the main beam of the tricycle (B1) via the outer shell (B29), the front guide piece (B27) is clamped and embedded between the outer shell (B29) and the main beam of the tricycle (B1), the upper end of the guide groove e (B28) and the front end of the front positioning groove (B14) are covered by the cover plate (B30) to prevent detachment, and the outer end of the cover plate (B30) is connected and positioned by the outer shell (B29), the handlebar (B12) has a handlebar (B31) at the top and a control lever (B32) at the bottom and driving the steering, the inside of the transmission shaft (B32) is hollow and a metal dome (B33) is disposed near the upper end, one end of the metal dome (B33) is connected to the inner wall of the transmission shaft (B32), and the other end is connected to fixed manner to the elastic button (B34), and the outer end of the elastic button (B34) passes through the driving rod (B32), the handle (B31) is coaxially inserted and covered outside of the transmission shaft (B32), and the handle (B31) is provided with an opening for the elastic button (B34) to protrude and abut against the disassembly button (B35), the lower end of the handle (B31) is covered and secured to a shell (B37), the disassembly button (B35) is arranged horizontally between the handle (B31) and the shell (B37); the outer end of the disassembly button (B35) passes through the shell (B37), and the inner end is connected to the opening (B36).

5. Multifunctional foldable children's tricycle according to claim 1, characterized in that: the opening and closing angle adjusting assembly which comprises a left swinging member (A3) and a swinging member straight (A4) and which pass through a vertical rotating rod (A2) in the rear frame (B3) to rotate and connect with each other, there is a relief opening (A6) for the installation of the synchronizing plate (A5) between the left swinging part (A3) and the right swinging part (A4), the synchronizing plate (A5) coincides with the center of the left and right swinging parts and passes through the rotary rod (A2), and a bar-shaped hole (A7) is opened through the synchronous plate (A5), a left synchronous bar (A8) is hinged on the lower end surface of the left swinging part (A3), and a synchronous bar right (A9) is articulated on the opposite surface of the right oscillating part (A4) and the lower end surface of the left swinging part (A3), the left synchronous band (A8) is located on the upper and lower sides of the bar-shaped hole (A7) away from the hinged side of the left oscillating piece (A3) and the right synchronous band (A9) is apart from the hinge side of the right oscillating piece (A4), respectively, and is synchronized by one of the round rods (A10) which cross tower turn the hinges, the strip-shaped hole (A7) is vertically opened near the rear end of the synchronization plate (A5), the bar-shaped hole (A7) extends forwards and backwards rear, and the left synchronous bar (A8) and the right synchronous bar (A9) both extend obliquely rearward from the bar-shaped hole (A7).

6. Multi-functional foldable children's tricycle according to claim 5, characterized in that: the left rocker block (A3) which comprises a cylindrical left rocker (A11) and a left stabilizer (A12) fixedly connected to the left side of the left swing block (A11), and the right swing block (A4) consists of a cylindrical part, the upper right swing block (A13) and the lower right swing block (A14) are clamped to the upper and lower sides of the swing block left (A11), the upper right swing block (A13) is fixedly connected to the right leg (A15) symmetrical to the left leg (A12) on the right side of the lower right swing block (A14), and the opening relief valve (A6) is opened on the lower right oscillating block (Between A14) and the left pendular block (A11), the upper right oscillating block (A13) is penetrated vertically by a quasi-elliptical through hole (A16), a block limit (A17) is ins aired in the through hole (A16), and the inner wall of the through hole (A16) protrudes with a convex line (A18), the upper surface of the left swing block (A11) is concave downward, and there is a groove limit block (A19) for inserting the lower end of the limit block (A17), the limit groove (A19) extends arcuately along the circumferential direction of the left swing block (A11), and the upper surface of the limiting block (A17) is provided with at least two vertically extending transposition holes (A20), the transposition holes (A20) are provided with springs (A21), an adjustment button (A22) is provided at the top of the limiting block (A17) to cooperate with the two cylinder transposition springs, at least two left positioning holes (A23) penetrate vertically through the left oscillating block (A11), the upper right oscillating block (A13) is provided with at least two straight positioning holes (A24) so adapted re pivoted to the left positioning hole (A23), when at least one of the right positioning hole (A24) and the left positioning hole (A23) are coaxial, the pin (A25) is sequentially inserted into the hole left positioning hole (A23) and the right positioning hole (A24) up and down for positioning.

7. Multi-functional foldable children's tricycle according to claim 6, characterized in that: once the left swing block (A11) is combined with the upper right swing block (A13) and the lower right swing block (A14), an outer cover (A26) is provided with a mouthpiece (A27); the rotary rod (A2) extends downward from the top of the outer cover (A26) and passes through the outer cover (A26), a support plate (A28) is placed between the outer cover (A26) and the limiting block (A17), and the support plate (A28) is fixedly connected to the outer cover (A26), the outer cover (A26) is provided with a round hole (A29) for protruding the adjusting knob (A22), the side of the round hole (A29) close to the support plate (A28) is coaxial with the round hole (A29) and has a detachment prevention groove (A30) whose diameter is larger than the round hole (A29), the inner end of the adjusting knob (A22) cooperates with the detachment prevention groove (A30) through the protruding rim on its outer periphery to prevent it from falling off, and the rear end of the knob adjuster (A22) protrudes with top block (A31) to the rear, top block (A31) passes through the top plate ort (A28) to cooperate with the sliding block (A32) integral with the top of the two springs, the support plate (A28) is provided with a sliding hole (A33) for the upper block (A31) to pass through and s sinks into the sliding block (A32).

8. Multi-functional foldable children's tricycle according to claim 6, characterized in that: the lower end of the left rocker block (A11) which protrudes downward with the left limit plate (A34) having the same thickness as the left synchronous band (A8), the left limit plate (A34) extends horizontally towards the center and crosses the rotary rod (A2), the upper surface of the lower right oscillating block (A14) protrudes upwards with the plate right limiting plate (A35) of the same thickness as the right synchronous band (A9), and the right limiting plate (A35) extends horizontally towards the center through the rotary rod (A2) transversely, the upper surface of the block right lower oscillator (A14) protrudes upward with a right limit plate (A35) of the same thickness as the right synchronous band (A9), and the right limit plate (A35) extends horizontally towards the center through the you rotating ge (A2) transversely, an arc-shaped protection plate (A36) is fixed on the side edge of the left rocker block (A11) and the left support leg (A12), the upper end of the plate plate (A36) extends vertically at the same level as the upper end of the upper right rocker block (A13), and the lower end of the protection plate (A36) extends vertically at the same level as the lower part end of the lower right rocker block (A14), the end is fixedly connected to the outer wall of the left rocker block (A11).

9. Multifunctional folding tricycle for children according to claim 1, characterized in that: the folding assembly comprises a piece of sheet metal (C3) integral with the rear frame (B3) and of U-section, the two sides from the lower end of the sheet metal part (C3) protrude downward with convex parts (C4) and are hinged to the main beam of the tricycle (C9) through the convex parts (C4), the sheet metal part (C3) is provided with a folding button (C5) extending vertically and crossing the sheet metal part (C3) at the top, the lower end of the folding button (C5) is connected to the inner bottom of the sheet metal part (C3) through the return spring (C6), and a hook (C7) protrudes horizontally from the front surface of the folding button (C5) and passes through the sheet metal part (C7), the main beam of the tricycle (C9) is hooked and positioned, and the rear end of the tricycle main beam (C9) is fixedly connected to a vertical connecting plate (C10), the two ends of the connecting plate (C10) extend backward with wing-shaped plates (C11), and the lower ends of the two wing-shaped plates correspond to the two convex parts and are hinged through the axis (C12), the connecting plate (C10) is provided with a notch (C8) for hooking with the hook (C7), the sheet metal part is provided with a complementary notch (C8) and a release opening (C13) for moving the hook (C7) up and down, the lower end of the folding button (C5) is provided upwards with 'a circular limiting groove (C14) bearing against the return spring (C6).

10. A method of operating a multifunctional foldable children's tricycle, characterized by adopting the mode of operation of any type of multifunctional foldable children's tricycle as described in one of claims 1 to 9, and proceeding according to the following steps:
a) When the children's tricycle needs to turn right, first turn the steering handle (B4) to the right to rotate the rear positioning block (B5) and pull the right cable (B7) to the stretch during rotation, at this time, the left wire rope (B6) is forced to stretch forward, that is, it synchronously drives the front positioning block (B13) to turn right, then drives the handlebar (B12) to turn right, that is, the front wheel (A1) completes the right turn of the tricycle for the child, the reverse process is performed to turn on the left, at the same time, the slider (A32) slides on the sheet metal part (C3) through the upper connection of the spring (A21), the top is connected with the adjustment knob (A22), and the adjustment knob (A22) is released to complete the rotation;
b) when it is necessary to adjust the opening and closing angle between the rear wheels, the pin (A25) must first be removed, then the adjustment button (A22) should be pressed down, so that the upper block (A31) pushes the slider (A32) of the sliding hole (A33); then press it into the transposition hole (A20), the spring (A21) is compressed, then one of the legs can be swung in and out, that is, the right leg (A15) can be swung inward, then drive the right synchronous bar (A9) to swing forward in the bar-shaped hole (A7) and swing the left synchronous bar (A8) forward into the bar-shaped hole (A7) synchronously through the connection of the rod synchronous turn (A10), that is, to drive the left stabilizer (A12) to rotate to inside synchronously to realize synchronous rotation;
when the rear frame (B3) needs to be folded, by pressing the folding button (C5), the return spring (C6) is compressed, the hook (C7) descends, and the entire rear frame (B3) can be swung to the front around the point of articulation at the same time; at this time, the hook (C7) must be taken out of the notch, then the folding button (C5) can be released, and the return spring (C6) resets, and the folding process of the rear frame (B3) and the main beam (C9) is complete.
